(19) United States
(12) Patent Application Publication
(10) Pub. No.: US 2024/0013705 A1
(43) Pub. Date: Jan. 11, 2024

(54) PIXEL DRIVING CIRCUIT, DISPLAY PANEL, AND DISPLAY DEVICE

(71) Applicant: Wuhan China Star Optoelectronics Semiconductor Display Technology Co., Ltd., Wuhan (CN)

(72) Inventors: Xuanyun WANG, Wuhan (CN); Chao DAI, Wuhan (CN)

(21) Appl. No.: 17/287,535

(22) PCT Filed: Mar. 26, 2021
(86) PCT No.: PCT/CN2021/083340

§ 371 Date: Sep. 22, 2022

(30) Foreign Application Priority Data
Mar. 16, 2021 (CN) 202110282684.9

(51) Int. Cl. G09G 3/32

(52) U.S. Cl. CPC G09G 3/32; G09G 2330/021; G09G 2320/0233; G09G 2300/0842; G09G 2300/0819

(57) ABSTRACT

A pixel driving circuit, a display panel, and a display device are described. The pixel driving circuit has an initialization unit and a compensation unit. At least one of the compensation unit or the Initialization unit includes two transistors connected in series. An active layer of at least one of the two transistors has an oxide semiconductor, so as to utilize a low leakage current characteristic of the transistor with the oxide semiconductor to improve a light-emitting stability of the light-emitting device, which is beneficial for the display panel to achieve a high-screen refresh rate display.

### FIELD OF DISCLOSURE

The present disclosure relates to displays, and more particularly to a pixel driving circuit, a display panel, and a display device.

### BACKGROUND OF DISCLOSURE

Although a large-size display device can provide a relatively large area of information interaction window, in order to ensure that the display device has a better display effect, the display device requires a higher screen refresh rate. However, the high screen refresh rate requirement and the transistor used in the pixel driving circuit for driving the display device have leakage current problems, which will lead to an increase in a power consumption of the display device.

### SUMMARY OF DISCLOSURE

An embodiment of the present application provide a pixel driving circuit, a display panel, and a display device, which can reduce a power consumption of the display panel.

An embodiment of the present application provides a pixel driving circuit, which includes a light-emitting device, a driving unit, an initialization unit, and a compensation unit. The driving unit is connected between a first voltage terminal and the light-emitting device, wherein the driving unit comprises a driving transistor. The initialization unit is connected between a gate of the driving transistor and an initialization voltage terminal. The compensation unit is connected between the gate of the driving transistor and one of a source or a drain of the driving transistor, wherein at least one of the initialization unit or the compensation unit comprises two transistors connected in series, and an active layer of at least one of the two transistors comprises an oxide semiconductor.

Optionally, in some embodiments of the present application, the initialization unit comprises a first initialization transistor and a second initialization transistor connected in series, wherein an active layer of the first initialization transistor comprises the oxide semiconductor, and a semiconductor material included in an active layer of the second initialization transistor is different from a semiconductor material included in the active layer of the first initialization transistor.

Optionally, in some embodiments of the present application, a gate of the first initialization transistor is connected to a first scan signal line, one of a source or a drain of the first initialization transistor is connected to the initialization voltage terminal, and the other of the source or the drain of the first initialization transistor is connected to one of a source or a drain of the second initialization transistor.

A gate of the second initialization transistor is connected to the second scan signal line, and the other of a source or a drain of the second initialization transistor is connected to the gate of the driving transistor.

Optionally, in some embodiments of the present application, the compensation unit comprises a first compensation transistor and a second compensation transistor connected in series, wherein an active layer of the first compensation transistor comprises the oxide semiconductor, and a semiconductor material included in an active layer of the second compensation transistor is different from the semiconductor material included in the active layer of the first compensation transistor.

Optionally, in some embodiments of the present application, a gate of the first compensation transistor is connected to a third scan signal line, one of a source or a drain of the first compensation transistor is connected to one of the source or the drain of the driving transistor, and the other of the source or the drain of the first compensation transistor is connected to one of a source or a drain of the second compensation transistor.

A gate of the second compensation transistor is connected to a fourth scan signal line, and the other of the source or the drain of the second compensation transistor is connected to the gate of the driving transistor.

Optionally, in some embodiments of the present application, the pixel driving circuit further comprises a reset unit and a light-emitting control unit.

The reset unit is connected between a reset voltage terminal and an anode of the light-emitting device, wherein the reset unit includes a reset transistor, one of a source or a drain of the reset transistor is connected to the reset voltage terminal, and the other of the source or the drain of the reset transistor is connected to the anode of the light-emitting device.

The light-emitting control unit comprises a first switching transistor and a second switching transistor, wherein one of a source or a drain of the first switching transistor is connected to the first voltage terminal, the other of the source or the drain of the first switching transistor is connected to one of the source or the drain of the driving transistor, one of a source or a drain of the second switching transistor is connected to one of the source or the drain of the driving transistor, and the other of the source or the drain of the second switching transistor is connected to the anode of the light-emitting device.

A gate of the reset transistor, a gate of the first switching transistor, and a gate of the second switching transistor are all connected to a light-emitting control signal line.

Optionally, in some embodiments of the present application, an active layer of the reset transistor comprises an oxide semiconductor, wherein a conduction channel of the reset transistor is of a different type from a conduction channel of the first switching transistor and the second switching transistor.

Optionally, in some embodiments of the present application, the first initialization transistor is an N-type transistor, and the second initialization transistor is a P-type transistor.

Optionally, in some embodiments of the present application, the first compensation transistor is an N-type transistor, and the second compensation transistor is a P-type transistor.

Optionally, in some embodiments of the present application, the pixel driving circuit further comprises a data writing unit and a storage unit.

The data writing unit is connected between a data signal line and one of the source or the drain of the driving transistor, wherein the data writing unit comprises a data transistor, a gate of the data transistor is connected to a fourth scan signal line, one of a source or a drain of the data transistor is connected to the data signal line, and the other of the source or the drain of the data transistor is connected to one of the source or the drain of the driving transistor.

The storage unit comprises a storage capacitor, wherein the storage capacitor is connected in series between the first voltage terminal and the gate of the driving transistor.

An embodiment of the present application further provides a display panel comprising a light-emitting device and a pixel driving circuit for driving the light-emitting device to emit light, wherein the pixel driving circuit comprises a first transistor, a second transistor, a third transistor, a fourth transistor, and a fifth transistor.

A gate of the second transistor is connected to a first scan signal line, and one of a source or a drain of the second transistor is connected to an initialization voltage terminal. A gate of the third transistor is connected to a second scan signal line, one of a source or a drain of the third transistor is connected to the other of the source or the drain of the second transistor, and the other of the source or the drain of the third transistor is connected to a gate of the first transistor. A gate of the fourth transistor is connected to a third scan signal line, and one of a source or a drain of the fourth transistor is connected to one of a source or a drain of the first transistor. A gate of the fifth transistor is connected to a fourth scan signal line, one of a source or a drain of the fifth transistor is connected to the other of the source or the drain of the fourth transistor, and the other of the source or the drain of the fifth transistor is connected to a gate of the first transistor.

At least one of the second transistor, the third transistor, the fourth transistor, or the fifth transistor includes an active layer having an oxide semiconductor.

Optionally, in some embodiments of the present application, an active layer of the second transistor and an active layer of the fourth transistor both comprise the oxide semiconductor, and an active layer of the third transistor and an active layer of the fifth transistor both include silicon semiconductor.

Optionally, in some embodiments of the present application, the pixel driving circuit further comprises: a sixth transistor, a seventh transistor, an eighth transistor, a ninth transistor, and a first capacitor.

A gate of the sixth transistor is connected to a light-emitting control signal line, one of a source or a drain of the sixth transistor is connected to a reset voltage terminal, and the other of the source or the drain of the sixth transistor is connected to an anode of the light-emitting device. A gate of the seventh transistor is connected to a fourth scan signal line, one of a source or a drain of the seventh transistor is connected to a data signal line, and the other of the source or the drain of the seventh transistor is connected to one of the source or the drain of the first transistor. A gate of the eighth transistor is connected to the light-emitting control signal line, one of a source or a drain of the eighth transistor is connected to a first voltage terminal, and the other of the source or the drain of the eighth transistor is connected to one of the source or the drain of the first transistor connected to the source or the drain of the seventh transistor. A gate of the ninth transistor is connected to the light-emitting control signal line, one of a source or a drain of the ninth transistor is connected to one of the source or the drain of the first transistor connected to the source or the drain of the fourth transistor, and the other of the source or the drain of the ninth transistor is connected to the anode of the light-emitting device. The first capacitor is connected in series between the first voltage terminal and the gate of the first transistor.

Optionally, in some embodiments of the present application, the sixth transistor comprises an active layer having an oxide semiconductor, the sixth transistor is an N-type transistor, and the eighth transistor and the ninth transistor are P-type transistors.

An embodiment of the present application also provides a display device including any one of the above-mentioned pixel driving circuits or any one of the above-mentioned display panels.

Compared with conventional technologies, an embodiment of the present application provides a pixel driving circuit, a display panel, and a display device. The pixel driving circuit includes a light-emitting device, a driving unit, an initialization unit, and a compensation unit. The driving unit is connected between a first voltage terminal and the light-emitting device, wherein the driving unit comprises a driving transistor. The initialization unit is connected between a gate of the driving transistor and an initialization voltage terminal. The compensation unit is connected between the gate of the driving transistor and one of a source or a drain of the driving transistor, wherein at least one of the initialization unit or the compensation unit comprises two transistors connected in series, and an active layer of at least one of the two transistors comprises an oxide semiconductor, such that a low leakage current characteristic of the transistor whose active layer includes the oxide semiconductor can reduce a problem of large power consumption caused by a large leakage current of the transistor. Therefore, the display panel adopting the pixel driving circuit can reduce a power consumption of the display panel while meeting the requirement of high screen refresh rate. Further, the problem of uneven brightness of the light-emitting device can also be improved, and a display quality of the display panel using the pixel driving circuit can be improved.

### DESCRIPTION OF DRAWINGS

FIGS. 1A to 1E are schematic diagrams of circuit structures of pixel driving circuits provided by embodiments of the present application.

FIG. 2 is a working timing diagram of the pixel driving circuit shown in FIG. 1E.

FIG. 3 is a schematic structural diagram of a display panel provided by an embodiment of the present application.

FIGS. 4A to 4E are schematic diagrams of circuit structures of pixel driving circuits provided by embodiments of the present application.

### DETAILED DESCRIPTION OF PREFERRED EMBODIMENTS

In order to make the purpose, technical solutions, and effects of this application clearer and clearer, the following further describes this application in detail with reference to the accompanying drawings and examples. It should be understood that the specific embodiments described here are only used to explain the present application and are not used to limit the present application.

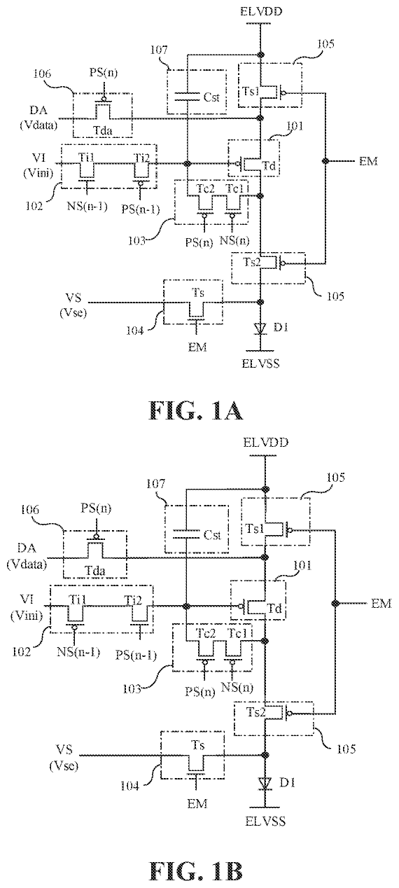

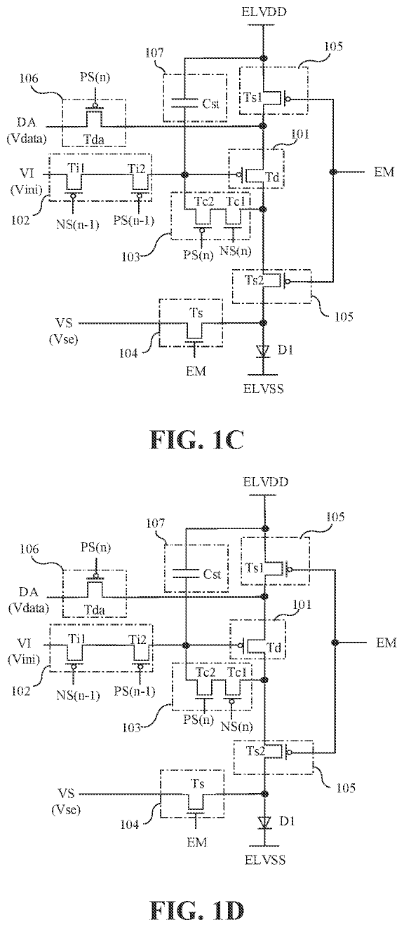

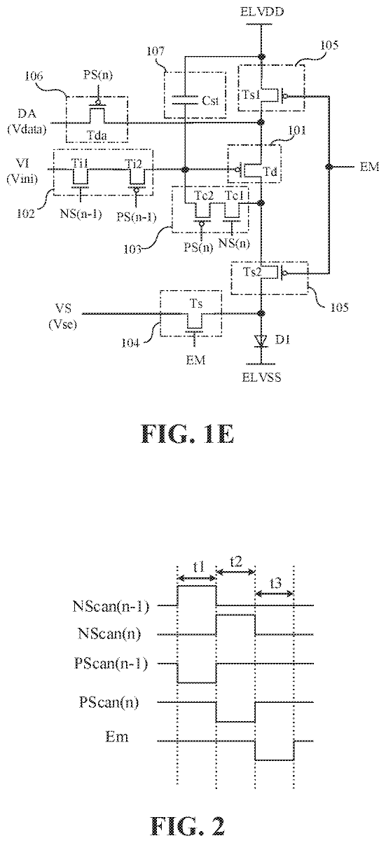

Please refer to FIG. 1A to FIG. 1E for schematic diagrams of circuit structure of the pixel driving circuit provided by the embodiments of the present application. FIG. 2 is a working timing diagram of the pixel driving circuit shown in FIG. 1E. An embodiment of the present application provides a pixel driving circuit. The pixel driving circuit includes a light-emitting device D1, a driving unit 101, an initialization unit 102, and a compensation unit 103.

Optionally, the light-emitting device D1 includes an organic light-emitting diode, a sub-millimeter light-emitting diode, and a micro light-emitting diode.

The driving unit 101 is connected between a first voltage terminal ELVDD and the light-emitting device D1, and the driving unit 101 is used to drive the light-emitting device D1 to emit light. The driving unit 101 includes a driving transistor Td.

The initialization unit 102 is connected between a gate of the driving transistor Td and the initialization voltage terminal VI. The initialization unit 102 is configured to transmit an initialization signal Vinit to the gate of the driving transistor Td according to the initialization control signal. A gate voltage of the driving transistor Td is initialized.

The compensation unit 103 is connected between the gate of the driving transistor Td and one of a source or a drain of the driving transistor Td. The compensation unit 103 is configured to transmit the data signal Vdata with the function of compensating the threshold voltage to the gate of the driving transistor Td according to the compensation control signal, so as to compensate the threshold voltage of the driving transistor Td.

At least one of the initialization unit 102 or the compensation unit 103 includes two transistors connected in series. An active layer of at least one of the two transistors includes an oxide semiconductor, such that a low leakage current characteristic of the transistor whose active layer includes the oxide semiconductor can reduce a problem of large power consumption caused by a large leakage current of the transistor. Therefore, the display panel adopting the pixel driving circuit can reduce a power consumption of the display panel while meeting the requirement of high screen refresh rate.

In addition, the initialization unit 102 is connected between the gate of the driving transistor Td and the initialization voltage terminal VI, and the compensation unit 103 is connected between the gate of the driving transistor Td and one of the source or the drain of the driving transistor Td. Therefore, if the transistor included in the initialization unit 102 includes an active layer with the oxide semiconductor, an influence of the initialization voltage terminal VI on the gate voltage of the driving transistor Td can be reduced, and the gate voltage of the driving transistor Td is ensured to be stable. If the transistor included in the compensation unit 103 includes an active layer having the oxide semiconductor, the influence of one of the source or the drain of the driving transistor Td on the gate voltage of the driving transistor Td can be reduced, and the gate voltage of the driving transistor Td is ensured to be stable. Therefore, when the transistor included in the initialization unit 102 and/or the compensation unit 103 includes an active layer having the oxide semiconductor, the stability of the gate voltage of the driving transistor Td can be improved. Therefore, the problem of uneven brightness of the light-emitting device D1 is improved, the light-emitting stability of the light-emitting device D1 is improved, and the display quality of the display panel using the pixel driving circuit is improved.

Optionally, the oxide semiconductor includes a metal oxide semiconductor. Further, the oxide semiconductor includes materials such as indium gallium zinc oxide, zinc oxide, tin oxide, or indium oxide.

Hereinafter, embodiments in which the transistor included in the initialization unit 102 and/or the compensation unit 103 includes an active layer having the oxide semiconductor will be described respectively.

Specifically, it is described by taking an example that the transistor included in the initialization unit 102 includes an active layer having the oxide semiconductor. Please continue to refer to FIGS. 1A to 1B. The initialization unit 102 includes a first initialization transistor Ti1 and a second initialization transistor Ti2 connected in series. An active layer of the first initialization transistor Ti1 and/or an active layer of the second initialization transistor Ti2 includes the oxide semiconductor.

Further, please continue to refer to FIG. 1A, the active layer of the first initialization transistor Ti1 includes the oxide semiconductor. A semiconductor material included in the active layer of the second initialization transistor Ti2 is different from a semiconductor material included in the active layer of the first initialization transistor Ti1. Furthermore, the active layer of the second initialization transistor Ti2 includes silicon semiconductor. Optionally, the silicon semiconductor includes material such as monocrystalline silicon or polycrystalline silicon.

The first initialization transistor Ti1 has a relatively low leakage current characteristics than the second initialization transistor Ti2. Therefore, the pixel driving circuit can reduce power consumption through the first initialization transistor Ti1 and improve the problem of uneven luminance of the light-emitting device D1 through the first initialization transistor Ti1.

Similarly, please continue to refer to FIG. 1B, the active layer of the second initialization transistor Ti2 includes the oxide semiconductor. The semiconductor material included in the active layer of the first initialization transistor Ti1 is different from the semiconductor material included in the active layer of the second initialization transistor Ti2. In this way, the pixel driving circuit can reduce power consumption through the second initialization transistor Ti2, and the problem of uneven brightness of the light-emitting device D1 can be improved through the second initialization transistor Ti2. Furthermore, the active layer of the first initialization transistor Ti1 includes silicon semiconductor.

Similarly, the active layer of the first initialization transistor Ti1 and the active layer of the second initialization transistor Ti2 both include the oxide semiconductor, so that the pixel driving circuit can reduce power consumption through the joint action of the first initialization transistor Ti1 and the second initialization transistor Ti2. The problem of uneven brightness of the light-emitting device D1 can be improved by the first initialization transistor Ti1 and the second initialization transistor Ti2.

Specifically, it is described by taking an example in which the active layer of the transistor included in the compensation unit 103 includes the oxide semiconductor. Please continue to refer to FIGS. 1C to 1D, the compensation unit 103 includes a first compensation transistor Tc1 and a second compensation transistor Tc2 connected in series. An active layer of the first compensation transistor Tc1 and/or an active layer of the second compensation transistor Tc2 includes the oxide semiconductor.

Further, please continue to refer to FIG. 10, the active layer of the first compensation transistor Tc1 includes the oxide semiconductor. A semiconductor material included in the active layer of the second compensation transistor Tc2 is different from a semiconductor material included in the active layer of the first compensation transistor Tc1, so that the pixel driving circuit can pass through the first compensation transistor. Tc1 reduces power consumption, and the problem of uneven brightness of the light-emitting device D1 is improved by the first compensation transistor Tc1. Furthermore, the active layer of the second compensation transistor Tc2 includes silicon semiconductor. Optionally, the silicon semiconductor includes a material such as monocrystalline silicon or polycrystalline silicon.

Similarly, please continue to refer to FIG. 1D, an active layer of the second compensation transistor Tc2 includes the oxide semiconductor. The semiconductor material included in the active layer of the first compensation transistor Tc1 is different from the semiconductor material included in the active layer of the second compensation transistor Tc2, so that the pixel driving circuit reduces power consumption through the second compensation transistor Tc2. The second compensation transistor Tc2 is used to improve the uneven brightness of the light-emitting device D1. Furthermore, the active layer of the first compensation transistor Tc1 includes silicon semiconductor.

Similarly, the active layer of the first compensation transistor Tc1 and the active layer of the second compensation transistor Tc2 both include the oxide semiconductor, so that the pixel driving circuit can reduce power consumption through the joint action of the first compensation transistor Tc1 and the second compensation transistor Tc2. The problem of uneven brightness of the light-emitting device D1 can be improved by the first compensation transistor Tc1 and the second compensation transistor Tc2.

Specifically, it is described by taking an example in which the initialization unit 102 and the compensation unit 103 each include an active layer having the oxide semiconductor. The active layer of the first initialization transistor Ti1 and/or the active layer of the second initialization transistor Ti2, and the active layer of the first compensation transistor Tc1 and/or the active layer of the second compensation transistor Tc2 includes the oxide semiconductor, so that the pixel driving circuit reduces power consumption through the joint action of the initialization unit 102 and the compensation unit 103. In addition, the problem of uneven brightness of the light-emitting device D1 is improved by the initialization unit 102 and the compensation unit 103.

Further, please continue to refer to FIG. 1E, the active layer of the first initialization transistor Ti1 and the active layer of the first compensation transistor Tc1 both include the oxide semiconductor, and the active layer of the second initialization transistor Ti2 and the active layer of the second compensation transistor Tc2 both include silicon semiconductors, so that the pixel driving circuit reduces power consumption through the joint action of the first initialization transistor Ti1 and the first compensation transistor Tc1, and the first initialization transistor Ti1 and the first compensation transistor Tc1 can improve the uneven brightness of the light-emitting device D1.

Similarly, the active layer of the first initialization transistor Ti1 and the active layer of the second compensation transistor Tc2 both include the oxide semiconductor, and the active layer of the second initialization transistor Ti2 and the active layer of the first compensation transistor Tc1 both include silicon semiconductors, so that the pixel driving circuit reduces power consumption through the joint action of the first initialization transistor Ti1 and the second compensation transistor Tc2, and the problem of uneven brightness of the light-emitting device D1 is improved.

Similarly, the active layer of the second initialization transistor Ti2 and the active layer of the first compensation transistor Tc1 both include the oxide semiconductor, and the active layer of the first initialization transistor Ti1 and the active layer of the second compensation transistor Tc2 both include silicon semiconductors, so that the pixel driving circuit reduces power consumption through the joint action of the second initialization transistor Ti2 and the first compensation transistor Tc1, and the problem of uneven brightness of the light-emitting device D1 is improved.

Similarly, the active layer of the second initialization transistor Ti2 and the active layer of the first compensation transistor Tc1 both include the oxide semiconductor, and the active layer of the first initialization transistor Ti1 and the active layer of the second compensation transistor Tc2 both include silicon semiconductors, so that the pixel driving circuit reduces power consumption through the joint action of the second initialization transistor Ti2 and the first compensation transistor Tc1, and the problem of uneven brightness of the light-emitting device D1 is improved.

Similarly, the active layer of the second initialization transistor Ti2 and the active layer of the second compensation transistor Tc2 both include the oxide semiconductor, so that the pixel driving circuit reduces power consumption through the joint action of the second initialization transistor Ti2 and the second compensation transistor Tc2, and the problem of uneven brightness of the light-emitting device D1 is improved.

Similarly, it can be obtained of: an embodiment that the active layer of the first initialization transistor Ti1, the active layer of the second initialization transistor Ti2, and the active layer of the first compensation transistor Tc1 all include the oxide semiconductor; or, an embodiment that the active layer of the first initialization transistor Ti1, the active layer of the second initialization transistor Ti2, and the active layer of the second compensation transistor Tc2 all include the oxide semiconductor; or, an embodiment that the active layer of the first initialization transistor Ti1, the active layer of the first compensation transistor Tc1, and the active layer of the second compensation transistor Tc2 all include the oxide semiconductor; or, an embodiment that the active layer of the second initialization transistor Ti2, the active layer of the first compensation transistor Tc1, and the active layer of the second compensation transistor Tc2 all include the oxide semiconductor; or, an embodiment that the active layer of the first initialization transistor Ti1, the active layer of the second initialization transistor Ti2, the active layer of the first compensation transistor Tc1, and the active layer of the second compensation transistor Tc2 all include the oxide semiconductor. No repeatedly description herein is shown again.

Please continue to refer to FIGS. 1A to 1E. The first initialization transistor Ti1 and the second initialization transistor Ti2 need to be turned on at the same time, so as to initialize a gate voltage of the driving transistor Td. Therefore, the initialization control signal includes a first scan signal NScan(n−1) and a second scan signal PScan(n−1). The first scan signal NScan(n−1) is used to control the on and off of the first initialization transistor Ti1. The second scan signal PScan(n−1) is used to control the on and off of the second initialization transistor Ti2.

Similarly, the first compensation transistor Tc1 and the second compensation transistor Tc2 need to be turned on at the same time, so as to transmit the data signal Vdata with the function of the compensation threshold voltage to the gate of the driving transistor Td. Therefore, the compensation control signal includes a third scan signal NScan(n) and a fourth scan signal PScan(n). The third scan signal NScan(n) is used to control the on and off of the first compensation transistor Tc1. The fourth scan signal PScan(n) is used to control the on and off of the second compensation transistor Tc2.

Please continue to refer to FIG. 1A to FIG. 1E. The gate of the first initialization transistor Ti1 is connected to the first scan signal line NS(n−1). One of the source or the drain of the first initialization transistor Ti1 is connected to the initialization voltage terminal VI. The other of the source or the drain of the first initialization transistor Ti1 is connected to one of the source or the drain of the second initialization transistor Ti2. The gate of the second initialization transistor Ti2 is connected to the second scan signal line PS(n−1). The other of the source or the drain of the second initialization transistor Ti2 is connected to the gate of the driving transistor Td.

The first scan signal line NS(n−1) is used to transmit the first scan signal NScan(n−1) to the gate of the first initialization transistor Ti1. The second scan signal line PS(n−1) is used to transmit the second scan signal PScan(n−1) to the gate of the second initialization transistor Ti2.

Please continue to refer to FIG. 1A to FIG. 1E. The gate of the first compensation transistor Tc1 is connected to the third scan signal line NS(n). One of the source or the drain of the first compensation transistor Tc1 is connected to one of the source or the drain of the driving transistor Td. The other of the source or the drain of the first compensation transistor Tc1 is connected to one of the source or the drain of the second compensation transistor Tc2. The gate of the second compensation transistor Tc2 is connected to the fourth scan signal line PS(n). The other of the source or the drain of the second compensation transistor Tc2 is connected to the gate of the driving transistor Td.

The third scan signal line NS(n) is used to transmit the third scan signal NScan(n) to the gate of the first compensation transistor Tc1. The fourth scan signal line PS(n) is used to transmit the fourth scan signal PScan(n) to the gate of the second compensation transistor Tc2.

Optionally, the driving transistor Td, the first initialization transistor Ti1, the second initialization transistor Ti2, the first compensation transistor Tc1, and the second compensation transistor Tc2 include N-type transistors or P-type transistors.

Further, the first initialization transistor Ti1 is an N-type transistor, and the second initialization transistor Ti2 is a P-type transistor. The first compensation transistor Tc1 is an N-type transistor, and the second compensation transistor Tc2 is a P-type transistor.

Please continue to refer to FIGS. 1A to 1E. The pixel driving circuit further includes a reset unit 104 and a light-emitting control unit 105.

The reset unit 104 is connected between a reset voltage terminal VS and an anode of the light-emitting device D1. The reset unit 104 is configured to transmit a reset signal Vse to the anode of the light-emitting device D1 according to the light-emitting control signal Em, so as to initialize the anode voltage of the light-emitting device D1.

The light-emitting control unit 105 is connected in series with the driving transistor Td. The light-emitting control unit 105 is configured to control the light-emitting device D1 to emit light according to the light-emitting control signal Em.

Optionally, the reset unit 104 includes a reset transistor Ts. One of a source or a drain of the reset transistor Ts is connected to the reset voltage terminal VS. The other of the source or the drain of the reset transistor Ts is connected to the anode of the light-emitting device D1.

The light-emitting control unit 105 includes a first switching transistor Ts1 and a second switching transistor Ts2. One of a source or a drain of the first switching transistor Ts1 is connected to the first voltage terminal ELVDD. The other of the source or the drain of the first switching transistor Ts1 is connected to one of the source or the drain of the driving transistor Td. One of a source or a drain of the second switching transistor Ts2 is connected to the other of the source or the drain of the driving transistor Td. The other of the source or the drain of the second switching transistor Ts2 is connected to the anode of the light-emitting device D1.

The gate of the reset transistor Ts, the gate of the first switching transistor Ts1, and the gate of the second switching transistor Ts1 are all connected to a light-emitting control signal line EM. The light-emitting control signal line EM is used to transmit the light-emitting control signal Em, so that the reset transistor Ts, the first switching transistor Ts1, and the second switching transistor Ts2 are all controlled by the light-emitting control signal Em. Number of signal lines used in the pixel driving circuit is reduced, thereby saving a wiring space of the display panel adopting the pixel driving circuit.

In order to avoid that the reset transistor Ts may affect the light-emitting state of the light-emitting device D1 when the reset transistor Ts, the first switching transistor Ts1, and the second switching transistor Ts2 are controlled by the same light-emitting control signal Em, a conduction channel of the reset transistor Ts can be of a different type from a conduction channel of the first switching transistor Ts1 and the second switching transistor Ts2. Specifically, the conduction channel of the reset transistor Ts is one of a P-type channel or an N-type channel, and the conduction channel of the first switching transistor Ts1 and the second switching transistor Ts2 is the other of a P-type channel or an N-type channel. Optionally, the conduction channel of the reset transistor Ts is an N-type channel, and the conduction channels of the first switching transistor Ts1 and the second switching transistor Ts2 are P-type channels. That is, the reset transistor Ts is an N-type transistor, and the first switching transistor Ts1 and the second switching transistor Ts2 are P-type transistors.

Further, the active layer of the reset transistor Ts includes an oxide semiconductor to reduce an influence of the reset voltage terminal VS on the light-emitting state of the light-emitting device D1.

Please continue to refer to FIGS. 1A to 1E. The pixel driving circuit further includes: a data writing unit 106 and a storage unit 107.

The data writing unit 106 is connected between the data signal line DA and one of the source or drain of the driving transistor Td. The data writing unit 106 is configured to transmit the data signal Vdata to one of the source or the drain of the driving transistor Td according to the fourth scan signal PScan(n).

The storage unit 107 is connected in series between the first voltage terminal ELVDD and the gate of the driving transistor Td. The storage unit 107 is used to maintain the gate voltage of the driving transistor Td.

Optionally, the data writing unit 106 includes a data transistor Tda. A gate of the data transistor Tda is connected to the fourth scan signal line PS(n). One of the source or drain of the data transistor Tda is connected to the data signal line DA. The other of the source or the drain of the data transistor Tda is connected to one of the source or the drain of the driving transistor Td.

The storage unit 107 includes a storage capacitor Cst, and the storage capacitor Cst is connected in series between the first voltage terminal ELVDD and the gate of the driving transistor Td.

A cathode of the light-emitting device D1 is connected to the second voltage terminal ELVSS.

Since the gate of the data transistor Tda and the gate of the second compensation transistor Tc2 are both connected to the fourth scan signal line PS(n), number of signal lines used by the pixel driving circuit can be further reduced.

Optionally, the potentials of the initialization voltage terminal VI and the reset voltage terminal VS may be equal or different.

Optionally, the driving transistor Td, the first initialization transistor Ti1, the second initialization transistor Ti2, the first compensation transistor Tc1, the second compensation transistor Tc2, the reset transistor Ts, the first switching transistor Ts1, the second switching transistor Ts2, and the data transistor Tda may be field effect transistor. Further, the field effect transistor includes a thin film transistor.

The working principle of the pixel driving circuit will be described in detail below in conjunction with FIG. 1E and FIG. 2. The working principle when the pixel driving circuit adopts the circuit structure shown in FIG. 1A to FIG. 1D is similar to the working principle when the pixel driving circuit adopts the circuit structure shown in FIG. 1E, and will not be repeated here.

Please continue to refer to FIG. 1E and FIG. 2. In one example, the driving transistor Td, the second initialization transistor Ti2, the second compensation transistor Tc2, the first switching transistor Ts1, the second switching transistor Ts2, and the data transistor Tda are P-type silicon transistors. The first initialization transistor Ti1, the first compensation transistor Tc1, and the reset transistor Ts are N-type oxide transistors. The data transistor Tda and the second compensation transistor Tc2 share the fourth scan signal PScan(n). The reset transistor Ts shares the light-emitting control signal Em with the first switching transistor Ts1 and the second switching transistor Ts2. In the Nth frame period (N Frame), the initialization phase t1, the compensation phase t2, and the light-emitting phase t3 are included.

In the initialization phase t1: The first scan signal NScan(n−1) is at a high level. The second scan signal PScan(n−1) is low level. The light-emitting control signal Em is at a high level. The first initialization transistor Ti1 and the second initialization transistor Ti2 are turned on in response to the first scan signal NScan(n−1) and the second scan signal PScan(n−1), respectively. The reset transistor Ts is turned on in response to the light-emitting control signal Em. The voltage difference between the two ends of the storage capacitor Cst becomes larger. The storage capacitor Cst is charged. The initialization signal Vini is transmitted to the gate of the driving transistor Td via the first initialization transistor Ti1 and the second initialization transistor Ti2, so as to initialize the gate voltage of the driving transistor T1. The reset signal Vse is transmitted to the anode of the light-emitting device D1 through the reset transistor Ts, so as to reset the anode voltage of the light-emitting device D1. Optionally, the initialization signal Vini is a constant voltage signal of −3.5V.

In the compensation phase t2: The third scan signal NScan(n) is at a high level. The fourth scan signal PScan(n) is low level. The light-emitting control signal Em is at a high level. The first compensation transistor Tc1, the second compensation transistor Tc2, and the data transistor Tda are turned on in response to the third scan signal NScan(n) and the fourth scan signal PScan(n), respectively. The reset transistor Ts is turned on in response to the light-emitting control signal Em. The driving transistor Td is diode-connected. The driving transistor Td is turned on. The data signal Vdata is transmitted to the gate of the driving transistor Td via the data transistor Tda, the first compensation transistor Tc1, and the second compensation transistor Tc2. The existence of the storage capacitor Cst causes the gate voltage of the driving transistor Td to gradually rise to Vdata+Vth, thereby realizing compensation for the threshold voltage Vth of the driving transistor Td. The reset signal Vse is transmitted to the anode of the light-emitting device D1 through the reset transistor Ts, so as to reset the anode voltage of the light-emitting device D1.

In the light-emitting stage t3: The light-emitting control signal Em is at a low level relative to the first voltage terminal ELVDD. The first switching transistor Ts1 and the second switching transistor Ts2 are turned on. The driving transistor Td generates a driving current for driving the light-emitting device D1 to emit light, and the light-emitting device D1 emits light.

In the light-emitting phase t3, the pixel driving circuit: utilizes the first initialization transistor Ti1 and the second initialization transistor Ti2 in the off state to reduce the influence of the initialization signal Vini on the gate voltage of the driving transistor Td; and utilizes the first compensation transistor Tc1 and the second compensation transistor Tc2 in the off state to reduce the influence of one of the source or the drain of the driving transistor Td on the gate voltage of the driving transistor Td, so as to keep the gate voltage of the driving transistor Td stable. Therefore, the stable light-emitting of the light-emitting device D1 is ensured.

The present application provides a display panel. The display panel may include any of the above-mentioned pixel driving circuits. Optionally, the display panel includes a self-luminous display panel, a quantum dot display panel, a passive light-emitting display panel, and the like. When the display panel is a passive light-emitting display panel, the backlight of the display panel includes the light-emitting device D1, and the pixel driving circuit can be used to control the backlight of the display panel to emit light.

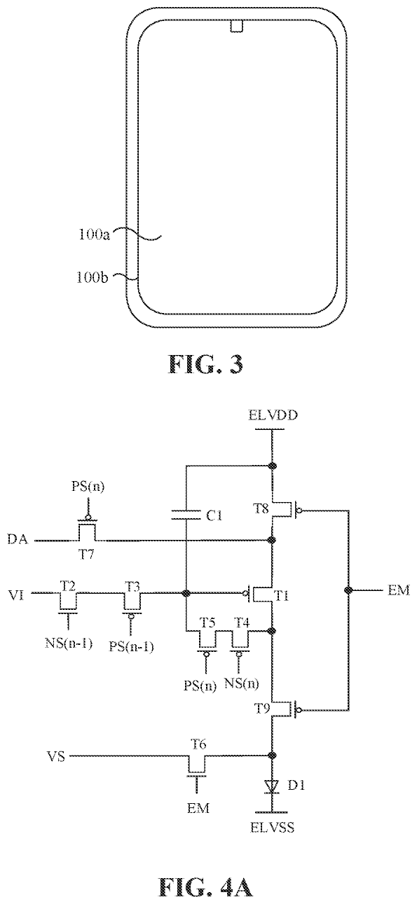

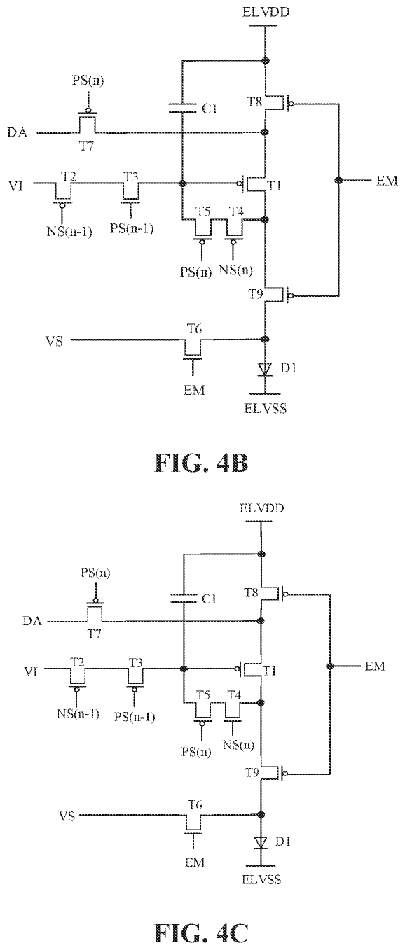

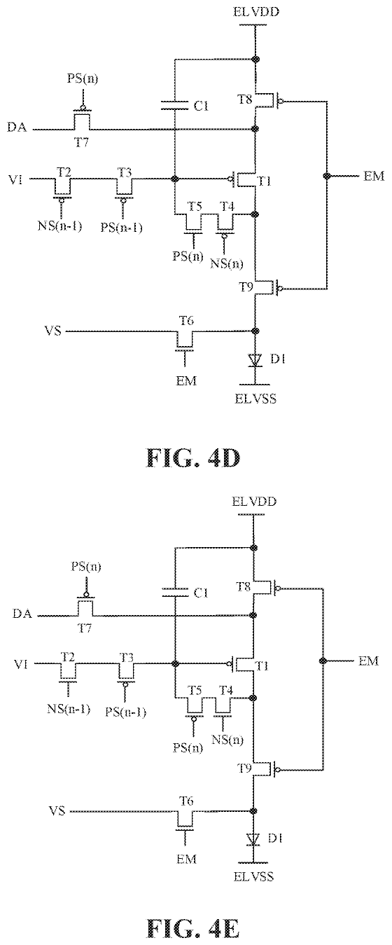

FIG. 3 is a schematic structural diagram of a display panel provided by an embodiment of the present application. FIGS. 4A to 4E are schematic diagrams of circuit structures of pixel driving circuits provided by embodiments of the present application. The application also provides a display panel. The display panel includes a display area 100a and a non-display area 100b. The display surface includes a light-emitting device D1 located in the display area 100a and a pixel driving circuit for driving the light-emitting device D1 to emit light. The pixel driving circuit includes: a first transistor T1, a second transistor T2, a third transistor T3, a fourth transistor T4, and a fifth transistor T5.

The gate of the second transistor T2 is connected to the first scan signal line NS(n−1), and one of a source or a drain of the second transistor T2 is connected to the initialization voltage terminal VI. A gate of the third transistor T3 is connected to a second scan signal line PS(n−1). One of a source or a drain of the third transistor T3 is connected to the other of the source or the drain of the second transistor T2. The other of the source or the drain of the third transistor T3 is connected to a gate of the first transistor T1. A gate of the fourth transistor T4 is connected to a third scan signal line NS(n). One of the source or the drain of the fourth transistor T4 is connected to one of the source or the drain of the first transistor T1. A gate of the fifth transistor T5 is connected to the fourth scan signal line PS(n). One of a source or a drain of the fifth transistor T5 is connected to the other of the source or the drain of the fourth transistor T4. The other of the source or the drain of the fifth transistor T5 is connected to the gate of the first transistor T1.

At least one of the second transistor T2, the third transistor T3, the fourth transistor T4, or the fifth transistor T5 includes an active layer of an oxide semiconductor. That is, at least one of the second transistor T2, the third transistor T3, the fourth transistor T4, or the fifth transistor T5 is an oxide transistor, so as to reduce the power consumption of the display panel through the low leakage current characteristic of the oxide transistor. It is beneficial for the display panel to achieve a high screen refresh rate display, and can improve the problem of uneven brightness of the light-emitting device D1, and improve the display quality of the display panel.

Further, please continue to refer to FIGS. 4A to 4D, at least one of the second transistor T2 or the third transistor T3, or at least one of the fourth transistor T4 or the fifth transistor T5 includes an active layer having the oxide semiconductor, so that the display panel passes through the second transistor T2 and the third transistor T3; or the fourth transistor T4 and the fifth transistor T5 reduce the power consumption of the display panel, and the problem of uneven light-emitting of the light-emitting device D1 is improved.

Specifically, the second transistor T2 includes an active layer having the oxide semiconductor, as shown in FIG. 4A; or the third transistor T3 includes an active layer having the oxide semiconductor, as shown in FIG. 4B, or each of the second transistor T2 and the third transistor T3 includes an active layer having the oxide semiconductor; or the fourth transistor T4 includes an active layer having the oxide semiconductor, as shown in FIG. 4C; or the fifth transistor T5 includes an active layer having the oxide semiconductor, as shown in FIG. 4D; or both the fourth transistor T4 and the fifth transistor T5 include an active layer having the oxide semiconductor.

Further, referring to FIG. 4E, at least one of the second transistor T2 or the third transistor T3, and at least one of the fourth transistor T4 or the fifth transistor T5 each include an active layer having the oxide semiconductor, so as to enable the display panel to reduce the power consumption of the display panel through the second transistor T2, the third transistor T3, the fourth transistor T4, and the fifth transistor T5, and to further improve the light-emitting device D1 is the problem of uneven light-emitting.

Specifically, the second transistor T2 and the fourth transistor T4 both include an active layer with the oxide semiconductor, and the third transistor T3 and the fifth transistor T5 both include an active layer with a silicon semiconductor. layer, so that the display panel reduces the influence of the initialization voltage terminal VI on the first transistor T1 by the second transistor T2, and the display panel reduces the influence of one of the source or the drain of the first transistor T1 on the gate voltage of the first transistor T1 by the fourth transistor T4. Therefore, the purpose of further improving the uneven light-emitting of the light-emitting device D1 is achieved.

Optionally, the second transistor T2 and the fourth transistor T4 may each further include an active layer having a silicon semiconductor, and the third transistor T3 and the fifth transistor T5 may also each include an active layer with an oxide semiconductor, which will not be repeated here.

Please continue to refer to FIGS. 4A to 4E, the pixel driving circuit further includes: a sixth transistor T6, a seventh transistor T7, an eighth transistor T8, a ninth transistor T9, and a first capacitor C1.

A gate of the sixth transistor T6 is connected to the light-emitting control signal line EM. One of a source or a drain of the sixth transistor T6 is connected to the reset voltage terminal VS. The other of the source or the drain of the sixth transistor T6 is connected to the anode of the light-emitting device D1.

A gate of the seventh transistor T7 is connected to the fourth scan signal line PS(n). One of a source or a drain of the seventh transistor T7 is connected to the data signal line DA. The other of the source or the drain of the seventh transistor T7 is connected to one of the source or the drain of the first transistor T1.

A gate of the eighth transistor T8 is connected to the light-emitting control signal line EM. One of a source or a drain of the eighth transistor T8 is connected to a first voltage terminal ELVDD, and the other of the source or the drain of the eighth transistor T8 is connected to one of the source or the drain of the first transistor T1 connected to the source or the drain of the seventh transistor T7.

A gate of the ninth transistor T9 is connected to the light-emitting control signal line EM. One of a source or a drain of the ninth transistor T9 is connected to one of the source or the drain of the first transistor T1 connected to the source or the drain of the fourth transistor T4, and the other of the source or the drain of the ninth transistor T9 is connected to the anode of the light-emitting device D1.

The first capacitor C1 is connected in series between the first voltage terminal ELVDD and the gate of the first transistor T1.

The cathode of the light-emitting device D1 is connected to the second voltage terminal ELVSS. Optionally, in the pixel driving circuit shown in FIGS. 4A to 4E, the plurality of light-emitting devices D1 in the display panel may adopt a common cathode connection method or a common anode connection method.

By connecting the gate of the sixth transistor T6, the gate of the eighth transistor T8, and the gate of the ninth transistor T9 to the light-emitting control signal line EM, the wiring space of the display panel can be saved.

In order to prevent the sixth transistor T6 from affecting the light-emitting state of the light-emitting device D1, a type of the conduction channel of the sixth transistor T6 is different from types of conduction channels of the eighth transistor T and the ninth transistor T9.

Specifically, the sixth transistor T6 includes one of an N-type transistor or a P-type transistor, and the eighth transistor T8 and the ninth transistor T9 include the other of a P-type transistor or an N-type transistor.

Optionally, the sixth transistor T6 includes an active layer having an oxide semiconductor to reduce the influence of the reset voltage terminal VS on the light-emitting state of the light-emitting device D1.

Optionally, the potentials of the initialization voltage terminal VI and the reset voltage terminal VS may be equal or unequal.

Optionally, the first transistor T1, the second transistor T2, the third transistor T3, the fourth transistor T4, the fifth transistor T5, the sixth transistor T6, the seventh transistor T7, the eighth transistor T8, and the ninth transistor T9 may be field effect transistors. Further, the field effect transistor includes a thin film transistor.

Optionally, the first transistor T1, the second transistor T2, the third transistor T3, the fourth transistor T4, the fifth transistor T5, and the seventh transistor T7 include N-type transistors or P-type transistors.

The present application also provides a display device, which includes any one of the above-mentioned pixel driving circuits or any one of the above-mentioned display panels. Further, the display device also includes a sensor and other devices.

The above only uses specific examples to describe the principles and implementation of the application, and the description of the above examples is only used to help understand the methods and core ideas of the application. At the same time, for those skilled in the art, according to the idea of this application, there will be changes in the specific implementation and the scope of application. In summary, the content of this specification should not be construed as a limitation on this application.

1. A pixel driving circuit, comprising:
a light-emitting device;
a driving unit connected between a first voltage terminal and the light-emitting device, wherein the driving unit comprises a driving transistor;
an initialization unit connected between a gate of the driving transistor and an initialization voltage terminal; and
a compensation unit connected between the gate of the driving transistor and one of a source or a drain of the driving transistor,
wherein at least one of the initialization unit or the compensation unit comprises two transistors connected in series, and an active layer of at least one of the two transistors comprises an oxide semiconductor.

2. The pixel driving circuit according to claim 1, wherein the initialization unit comprises a first initialization transistor and a second initialization transistor connected in series, wherein an active layer of the first initialization transistor comprises the oxide semiconductor, and a semiconductor material included in an active layer of the second initialization transistor is different from a semiconductor material included in the active layer of the first initialization transistor.

3. The pixel driving circuit according to claim 2, wherein:
a gate of the first initialization transistor is connected to a first scan signal line, one of a source or a drain of the first initialization transistor is connected to the initialization voltage terminal, and the other of the source or the drain of the first initialization transistor is connected to one of a source or a drain of the second initialization transistor; and
a gate of the second initialization transistor is connected to the second scan signal line, and the other of a source or a drain of the second initialization transistor is connected to the gate of the driving transistor.

4. The pixel driving circuit according to claim 1, wherein the compensation unit comprises a first compensation transistor and a second compensation transistor connected in series, wherein an active layer of the first compensation transistor comprises the oxide semiconductor, and a semiconductor material included in an active layer of the second compensation transistor is different from the semiconductor material included in the active layer of the first compensation transistor.

4. The pixel driving circuit according to claim 4, wherein:
a gate of the first compensation transistor is connected to a third scan signal line, one of a source or a drain of the first compensation transistor is connected to one of the source or the drain of the driving transistor, and the other of the source or the drain of the first compensation transistor is connected to one of a source or a drain of the second compensation transistor; and
a gate of the second compensation transistor is connected to a fourth scan signal line, and the other of the source or the drain of the second compensation transistor is connected to the gate of the driving transistor.

6. The pixel driving circuit according to claim 1, further comprising:
a reset unit connected between a reset voltage terminal and an anode of the light-emitting device, wherein the reset unit includes a reset transistor, one of a source or a drain of the reset transistor is connected to the reset voltage terminal, and the other of the source or the drain of the reset transistor is connected to the anode of the light-emitting device; and
a light-emitting control unit comprising a first switching transistor and a second switching transistor, wherein one of a source or a drain of the first switching transistor is connected to the first voltage terminal, the other of the source or the drain of the first switching transistor is connected to one of the source or the drain of the driving transistor, one of a source or a drain of the second switching transistor is connected to one of the source or the drain of the driving transistor, and the other of the source or the drain of the second switching transistor is connected to the anode of the light-emitting device,
wherein a gate of the reset transistor, a gate of the first switching transistor, and a gate of the second switching transistor are all connected to a light-emitting control signal line.

7. The pixel driving circuit according to claim 6, wherein an active layer of the reset transistor comprises an oxide semiconductor, wherein a conduction channel of the reset transistor is of a different type from a conduction channel of the first switching transistor and the second switching transistor.

8. The pixel driving circuit according to claim 2, wherein the first initialization transistor is an N-type transistor, and the second initialization transistor is a P-type transistor.

9. The pixel driving circuit according to claim 4, wherein the first compensation transistor is an N-type transistor, and the second compensation transistor is a P-type transistor.

10. The pixel driving circuit according to claim 1, further comprising:
a data writing unit connected between a data signal line and one of the source or the drain of the driving transistor, wherein the data writing unit comprises a data transistor, a gate of the data transistor is connected to a fourth scan signal line, one of a source or a drain of the data transistor is connected to the data signal line, and the other of the source or the drain of the data transistor is connected to one of the source or the drain of the driving transistor; and
a storage unit comprising a storage capacitor, wherein the storage capacitor is connected in series between the first voltage terminal and the gate of the driving transistor.

11. A display panel, comprising a light-emitting device and a pixel driving circuit for driving the light-emitting device to emit light, wherein the pixel driving circuit comprises:
a first transistor;
a second transistor, wherein a gate of the second transistor is connected to a first scan signal line, and one of a source or a drain of the second transistor is connected to an initialization voltage terminal;
a third transistor, wherein a gate of the third transistor is connected to a second scan signal line, one of a source or a drain of the third transistor is connected to the other of the source or the drain of the second transistor, and the other of the source or the drain of the third transistor is connected to a gate of the first transistor;
a fourth transistor, wherein a gate of the fourth transistor is connected to a third scan signal line, and one of a source or a drain of the fourth transistor is connected to one of a source or a drain of the first transistor; and
a fifth transistor, wherein a gate of the fifth transistor is connected to a fourth scan signal line, one of a source or a drain of the fifth transistor is connected to the other of the source or the drain of the fourth transistor, and the other of the source or the drain of the fifth transistor is connected to a gate of the first transistor;
wherein, at least one of the second transistor, the third transistor, the fourth transistor, or the fifth transistor includes an active layer having an oxide semiconductor.

12. The display panel according to claim 11, wherein an active layer of the second transistor and an active layer of the fourth transistor both comprise the oxide semiconductor, and an active layer of the third transistor and an active layer of the fifth transistor both include silicon semiconductor.

13. The display panel according to claim 11, wherein the pixel driving circuit further comprises:
a sixth transistor, wherein a gate of the sixth transistor is connected to a light-emitting control signal line, one of a source or a drain of the sixth transistor is connected to a reset voltage terminal, and the other of the source or the drain of the sixth transistor is connected to an anode of the light-emitting device;
a seventh transistor, wherein a gate of the seventh transistor is connected to a fourth scan signal line, one of a source or a drain of the seventh transistor is connected to a data signal line, and the other of the source or the drain of the seventh transistor is connected to one of the source or the drain of the first transistor;
an eighth transistor, wherein a gate of the eighth transistor is connected to the light-emitting control signal line, one of a source or a drain of the eighth transistor is connected to a first voltage terminal, and the other of the source or the drain of the eighth transistor is connected to one of the source or the drain of the first transistor connected to the source or the drain of the seventh transistor;
a ninth transistor, wherein a gate of the ninth transistor is connected to the light-emitting control signal line, one of a source or a drain of the ninth transistor is connected to one of the source or the drain of the first transistor connected to the source or the drain of the fourth transistor, and the other of the source or the drain of the ninth transistor is connected to the anode of the light-emitting device, and
a first capacitor connected in series between the first voltage terminal and the gate of the first transistor.

14. The display panel according to claim 13, wherein an active layer of the sixth transistor includes an oxide semiconductor, the sixth transistor is an N-type transistor, and the eighth transistor and the ninth transistor are P-type transistors.

15. A display device, comprising a display panel, the display panel comprising a light-emitting device and a pixel driving circuit connected to the light-emitting device, wherein the pixel driving circuit comprises:
a driving unit connected between a first voltage terminal and the light-emitting device, wherein the driving unit comprises a driving transistor;
an initialization unit connected between a gate of the driving transistor and an initialization voltage terminal for initializing a gate voltage of the driving transistor; and
a compensation unit connected between the gate of the driving transistor and one of a source or a drain of the driving transistor for compensating a threshold voltage of the driving transistor according to a data signal, wherein at least one of the initialization unit or the compensation unit comprises two transistors connected in series, and an active layer of at least one of the two transistors comprises an oxide semiconductor.

16. The display device according to claim 15, wherein the initialization unit comprises a first initialization transistor and a second initialization transistor connected in series, wherein an active layer of the first initialization transistor comprises the oxide semiconductor, and an active layer of the second initialization transistor comprises a silicon semiconductor.

17. The display device according to claim 15, wherein the compensation unit comprises a first compensation transistor and a second compensation transistor connected in series, wherein an active layer of the first compensation transistor comprises the oxide semiconductor, and an active layer of the second compensation transistor comprises a silicon semiconductor.

18. The display device according to claim 15, wherein the pixel driving circuit further comprises:
a reset unit connected between a reset voltage terminal and an anode of the light-emitting device for resetting the anode of the light-emitting device, wherein the reset unit comprises a reset transistor; and
a light-emitting control unit connected in series with the light-emitting device and the driving transistor, wherein the light-emitting control unit comprises a first switching transistor and a second switching transistor, wherein a gate of the reset transistor, a gate of the first switching transistor, and a gate of the second switching transistor are all connected to a light-emitting control signal line.

19. The display device according to claim 15, wherein the pixel driving circuit further comprises:
a data writing unit connected between a data signal line and one of the source or the drain of the driving transistor, wherein the data writing unit comprises a data transistor, and
a storage unit comprising a storage capacitor, wherein the storage capacitor is connected in series between the first voltage terminal and the gate of the driving transistor.

20. The display device according to claim 15, wherein the light-emitting device includes an organic light-emitting diode, a sub-millimeter light-emitting diode, or a miniature light-emitting diode.
